(19) United States
(12) Patent Application Publication
(10) Pub. No.: US 2026/0084484 A1
(43) Pub. Date: Mar. 26, 2026

(54) SLIM HVAC OUTLET FOR AN INSTRUMENT PANEL OF A VEHICLE

(71) Applicant: FCA US LLC, Auburn Hills, MI (US)

(72) Inventor: Paul H. Ams, Auburn Hills, MI (US)

(21) Appl. No.: 18/893,292

(22) Filed: Sep. 23, 2024

(51) Int. Cl. B60H 1/00

(52) U.S. Cl. CPC B60H 1/00207; B60H 1/00021; B60H 2001/00192; B60H 2001/00214

(57) ABSTRACT

An air outlet for a vehicle includes a first and second side walls each having upper and lower slots. Flexible upper and lower walls each have divider slots. The flexible upper wall engaging the first upper slots. The flexible lower wall engaging the lower slots. A coupling member couples a center portion of the flexible upper wall to a center portion of the flexible lower wall. The outlet has a plurality of divider walls. Each divider wall of the plurality of divider walls has a plurality of divider plates. Each divider wall is coupled between one of the first plurality of divider slots and one of the second plurality of divider slots. A control arm is coupled to one of the flexible upper wall or the flexible lower wall. The control arm moves the flexible upper wall, the flexible lower wall and the plurality of divider walls simultaneously.

### FIELD

The present disclosure relates to a heating ventilation and air conditioning (HVAC) system for a vehicle and, more particularly, to an air outlet for an instrument panel of a vehicle.

### BACKGROUND

This section provides background information related to the present disclosure which is not necessarily prior art.

HVAC systems typically used a directable air outlet for providing conditioned air to the passenger compartment of the vehicle. The air outlets sometimes have a cumbersome mechanism that is used to direct the air upwards and downwards. However, in typical systems, the amount of square area provided is large. By providing a large vent area, the designers of the interior of the vehicle are limited in the placement of other components. Slim outlets have been used in vehicles with drawbacks. However, slim outlets typically have poor aiming. Another problem with traditional slim outlets is that noise vibration and harshness is common. One source of noise is the turbulence caused from reducing the airflow from a generally large are duct to a narrow duct. Turbulence caused by the components of the duct may cause noise. Noise and vibration should be avoided in an automotive design to increase customer satisfaction.

Air outlets for HVAC systems typically use vanes for directing the air sideways and outwards and downwards. Slim outlets suffer from poor directionality in air distribution especially in the upward and downward direction.

### SUMMARY

This section provides a general summary of the disclosure and is not a comprehensive disclosure of its full scope or all of its features.

The present system provides a vertically slim outlet design suitable to meeting the needs of a modern car design having a narrow air outlet to provide improved directionality of the air.

In one aspect of the disclosure, an air outlet for a vehicle includes a first side wall having a first upper slot and a first lower slot. A second side wall has a second upper slot and a second lower slot. A flexible upper wall comprises a first plurality of divider slots. The flexible upper wall engages the first upper slot and the second upper slot. A flexible lower wall is spaced apart from the flexible upper wall comprising a second plurality of divider slots, the flexible lower wall engaging the first lower slot and the second lower slot. A coupling member couples a center portion of the flexible upper wall to a center portion of the flexible lower wall. A plurality of divider walls is provided. Each divider wall of the plurality of divider walls comprises a plurality of divider plates. Each divider wall is coupled between one of the first plurality of divider slots and second of the plurality of divider slots. A control arm is coupled to one of the flexible upper wall or the flexible lower wall. The control arm moves the flexible upper wall, the flexible lower wall and the plurality of divider walls simultaneously.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a high level diagrammatic view of a HVAC system within a vehicle having an outlet according to the present disclosure.

FIG. 1B is a diagrammatic view of a switch panel.

FIG. 1C is a perspective view of an adjustor relative to an outlet according to the present disclosure.

FIG. 2A is an exploded view of the outlet.

FIG. 2B is a side view of the divider wall in FIG. 2A in a straight position.

FIG. 2C is a top view of the divider wall of FIG. 2A.

FIG. 2D is a side view of the divider wall in a curved direction illustrating a downward direction of airflow.

FIG. 2E is a side view of the internal portions of the outlet 22 when the divider wall 78 is directing the air in a downward direction.

Corresponding reference numerals indicate corresponding parts throughout the several views of the drawings.

### DETAILED DESCRIPTION

Example embodiments will now be described more fully with reference to the accompanying drawings.

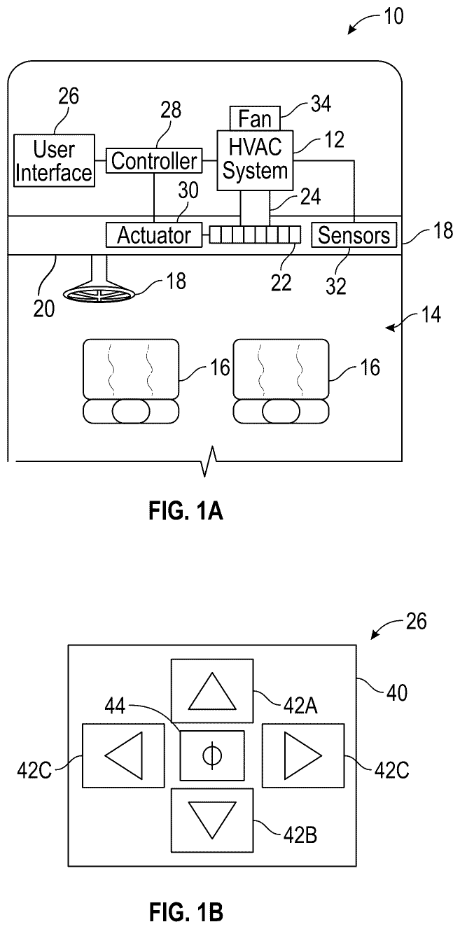

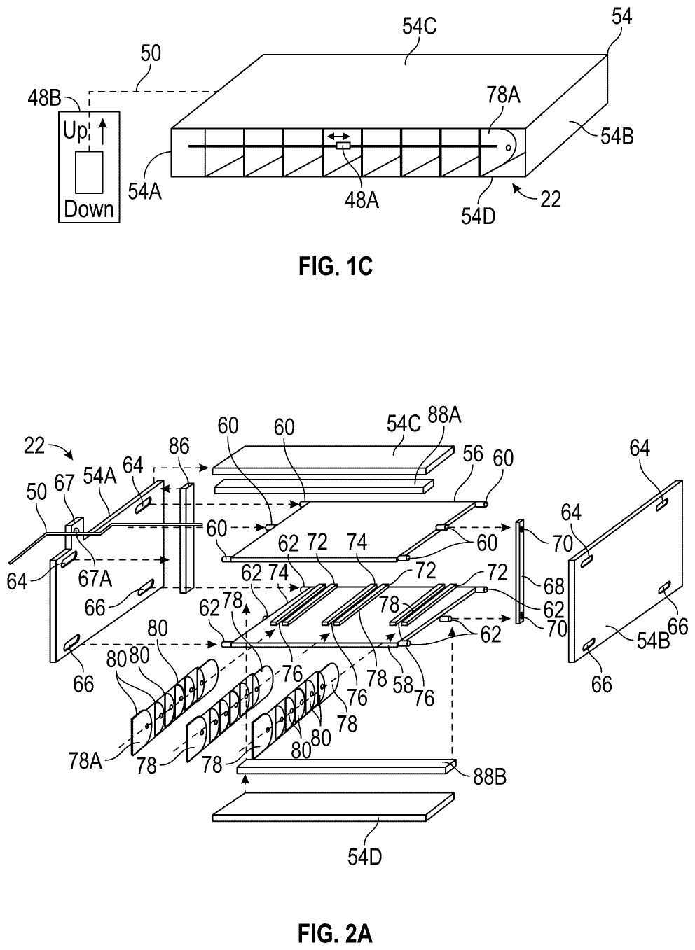

Referring now to FIG. 1A, a partial view of a vehicle 10 having a heating, ventilation and cooling system (HVAC) 12 is set forth. The heating, ventilation and cooling system 12 is used to heat and cool a passenger compartment 14 of the vehicle. The passenger compartment 14 is illustrated with front seats 16, a steering wheel 18 that is positioned in front of the driver front seat 16. An instrument panel 20 is also illustrated. The instrument panel 20 has an air outlet 22 that may be referred to as a vent. The outlet 22 is a slim outlet 22 in terms of the height relative to orientation within the vehicle 10. That is, the outlet 22 is narrow but extends laterally across a portion of the instrument panel 20. The outlet 22 receives conditioned air from a duct 24 which is in communication with the HVAC system 12. A user interface 26, such as button, dials or switches, are coupled to a controller 28. The controller 28 is processor based and is programmed to control the HVAC system 12. The controller 28 may also be used to control an actuator 30. The actuator 30 may be an automated actuator 30 that is used to adjust the direction of the vanes of the outlet 22 as described in greater detail below. It should be noted that the actuator 30 may also be manually activated by the use of a slide or other mechanical coupling. The actuator 30 may comprise a motor.

The HVAC system 12 may be automatically controlled by the user of sensors 32. That is, the sensor 32 may be a temperature sensor that is used to control the operation of a fan 34 and/or heating and cooling elements within the HVAC system according to the temperature settings provided by the vehicle operator through the user interface 26.

Although only one outlet 22 is illustrated, the instrument panel 20 and other places within the vehicle may have outlets positioned therein.

Referring now to FIG. 1B, one example of a user interface 26 is a switch panel 40. The switch panel 40, in this example, includes an up button 42A, a down button 42B, a left button 42C and a right button 42D. The buttons 42A-42D may be solid buttons that pivot or may be individual buttons. The switch panel 40 may also include an on/off button 44. The buttons 42, 44 may be used to control an electric actuator used for moving the vanes within the outlet 22 to a desired position. The up and down directions may be controlled individually versus the left and right buttons.

Referring now to FIG. 1C, an outlet 22 is illustrated having manual adjustors. In this example, a right/left adjustor 48A is used for laterally moving the outward end of the vanes left or right. The adjuster 48A is an elongated member coupled to the outward edges of the of the end segments 78A described in greater detail below. A portion of the adjuster 48A may be thicker to act as a handle. An adjustor 48B is illustrated in the down position. However, the adjustor 48B may be moved in an upward position as well. A control arm 50 may be coupled to the adjustor to move the inside of the outlet 22 as described in greater detail below.

The outlet 22 has a housing 54 that is formed of a left side wall 54A, a right side wall 54B, an upper wall 54C and a lower wall 54D.

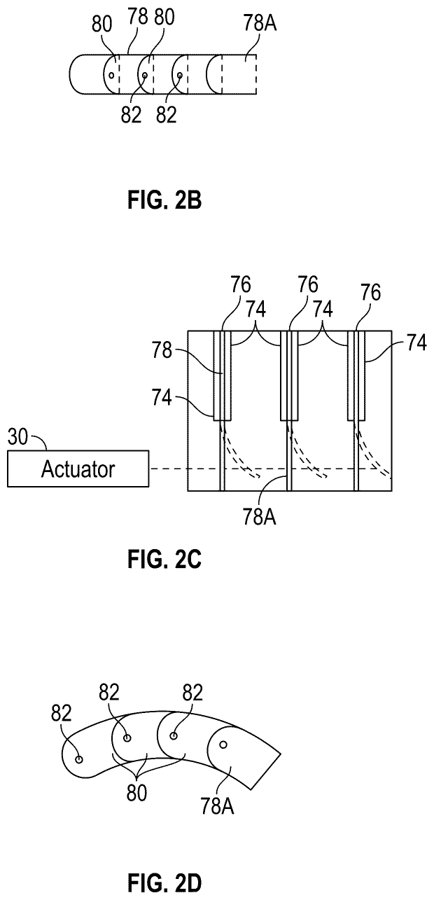

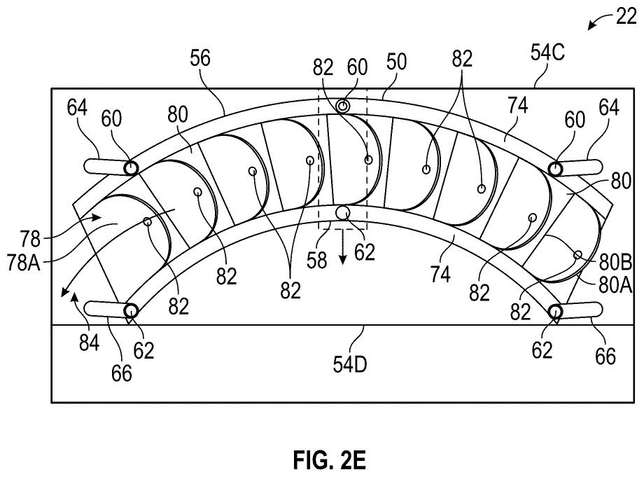

Referring now to FIGS. 2A-2E, the outlet 22 is illustrated in further detail. The outlet 22 is illustrated as an exploded view in FIG. 2A from the front or air outlet perspective. The left side wall 54A is illustrated with the right side wall 54B illustrated for simplicity. In this example, a flexible upper wall 56 is illustrated apart from a flexible lower wall 58. A plurality of extensions 60 extend from the lateral side of the flexible upper wall 56. The flexible upper wall 56 is generally planar with the extension 60 extending laterally. In this example, three extensions 60 are disposed on the lateral edges of the flexible upper wall. The three extensions on one lateral side to the flexible upper wall 56 have a corresponding extension 60 on the opposite lateral side. Opposite extensions 60 are collinear. In this example, the extensions 60 are cylindrical in shape.

The flexible lower wall 58 also has extensions 62 extending therefrom and are formed in a similar manner to extensions 60 described above. The extensions 62 are also cylindrical in shape. Three extensions are disposed on each side. Pairs of extensions 62 are colinear as is the extensions 60 on the flexible upper wall 56. In this example, the side walls 54A and 54B have upper slots 64 that receive the outermost extensions 60. Likewise, lower slots 66 are disposed directly beneath the upper slots 66 and receive the outermost extensions 62 of the flexible lower wall 58. The side wall 54B also has corresponding slots 64, 66. In a flat position, the extensions 60,62 are the outermost extent of the slots 64, 66. In a curved position, the extensions 60, 62 are at the innermost extent of the slots 64, 66 as illustrated in FIG. 2E. The extensions 60,62 slidably engage the slots 64, 66.

The control arm 50 may be coupled to the center extensions 60 or 62 (60 in this example) to control the vertical movement of the flexible upper wall 56 and the flexible lower wall 58. The control arm 50 is received in a flange 67 that has an opening 67A. The center extension 60 may receive a portion of the control arm 50 therein as best illustrated in FIG. 2E. However, the control arm 50 may be mounted externally on the extensions 62. A coupling member 68 is coupled to the extensions 60, 62 in the middle positions on the flexible upper wall 56 and the flexible lower wall 58, respectively. The coupling member 68 is on an opposite side of the flexible walls 56, 58 from the control arm 50 to allow the flexible walls 56, 58 to move together. An opening 70 may be provided in the coupling member 68 for receiving the center extensions 60, 62. The coupling member 68 allows the flexible upper wall 56 and the flexible lower wall 58 to move simultaneously as is best illustrated in FIGS. 2D and 2E.

The flexible upper wall 56 and the flexible lower wall may have divider holders 78 that extend longitudinally relative to the vehicle 10. The divider holders 78 have elongated walls 74 that have a slot 87 therebetween. The slots 76 are used to receive a divider wall 78. In this example, three divider walls 78 are provided. However, a greater number or a lesser number of divider walls may be provided. The divider walls 78 are flexible and are made of an end segment 78A that is disposed at the outlet end of the divider wall 78, at least a portion of which extends beyond the elongated walls 74 as shown in FIG. 2C. The end segment 78A is coupled to a plurality of segments 80 that are coupled together at a pivot point by a fastener such as by rivets 82. As is best illustrated in FIG. 2E, the elongated upper wall 74 may be provided on both the flexible upper wall 56 and the flexible lower wall 58. The slots 76 receive a divider wall 78. As the control arm 50 moves the center extension 60 and therefore the flexible upper wall 56 and the flexible lower wall 58 together with the coupling member 68, flexible movement in the upward and downward direction of the air traveling in FIG. 2D as indicated by the arrow 84 is provided. In this example, the arrow 84 indicates the movement of the air in the downward direction from the outlet 22. However, the control arm 50 may also move the center portions of the flexible upper wall 56 and the flexible lower wall 58 to a downward position and thus the air may be directed in an upward direction. The first side of the flexible walls 56 or 58 are coupled directly to the control arm 50 while the opposite side is coupled to a coupling member 68. Thus, the flexible upper wall 56 and the flexible wall 58 remain spaced apart the same distance even though they are flexed in a vertical direction in the desired amount as controlled by the vehicle operator.

A side seals 86 may also be provided to help seal the system from leakage when connecting to the duct 24. Although not shown, a second side seal 86 on the right side may be positioned adjacent to the side wall 54A. An upper seal 88A and lower seal 88B adjacent to the flexible upper wall 56 and the flexible lower wall 58 may also be provided to seal with the longitudinal portions of the duct. The seals 86, 88A and 88B help seal air leakage from the system as well as reduce any potential points for noise vibration and harshness. Various materials may be used for the seals including but not limited to urethane foam.

In FIG. 2C, a top view of the divider walls 78 is illustrated. The divider walls 78 are disposed in slots 76 formed between the pairs of elongated walls 74. The end segments 78A of the divider walls may extend outward from the slots 76 beyond the elongated walls 74. This allows the actuator 30 to direct the air from the outlet 22 laterally relative to the outlet 22. In the present example, the air is directed toward the right because the actuator 30 has linearly moved the end segment 78A of the divider wall 78 in a rightward direction. As mentioned above, the actuator 30 may be manually activated or may be controlled electrically by the controller 28 of FIG. 1A.

The segments 80 of the divider wall 78 may have a curved edge 80A and straight edge 80B which form D-shaped segments. The segments 80 overlap and the curvature of the curved edge 80A allows the walls to curve in the upper and lower directions as illustrated in FIGS. 2D and 2E to conform to the flexible upper wall 56 and flexible lower wall 58.

In operation, the user interface or the switches are used by the operator to move the divider walls in the vertical direction and the end segments in the lateral directions. That is, the air from the outlet 22 may be directed in an upward or downward direction or rightward or leftward direction relative to the vehicle so air from the outlet is directed as desired.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. 1steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An air outlet for a vehicle comprising:
a first side wall having a first upper slot and a first lower slot;
a second side wall having a second upper slot and a second lower slot;
a flexible upper wall comprising a first plurality of divider slots, the flexible upper wall engaging the first upper slot and the second upper slot;
a flexible lower wall spaced apart from the flexible upper wall comprising a second plurality of divider slots, the flexible lower wall engaging the first lower slot and the second lower slot;
a coupling member coupling a center portion of the flexible upper wall to a center portion of the flexible lower wall;
a plurality of divider walls, each divider wall of the plurality of divider walls comprising a plurality of divider plates, each divider wall coupled between one of the first plurality of divider slots and one of the second plurality of divider slots; and
a control arm coupled to one of the flexible upper wall or the flexible lower wall, the control arm moving the flexible upper wall, the flexible lower wall and the plurality of divider walls simultaneously.

2. The air outlet of claim 1 wherein the plurality of divider walls each comprise a plurality of segments.

3. The air outlet of claim 2 wherein the plurality of segments is coupled together at a pivot point.

4. The air outlet of claim 3 further comprising a rivet coupled to the pivot point.

5. The air outlet of claim 1 wherein the divider slots are formed between pairs of elongated walls coupled to the flexible upper wall and the flexible lower wall.

6. The air outlet of claim 1 wherein each divider wall comprises an end segment.

7. The air outlet of claim 6 wherein the end segment of each divider wall is coupled to an adjuster for adjusting for lateral movement.

8. The air outlet of claim 7 wherein the adjuster for lateral movement comprises an actuator.

9. The air outlet of claim 8 wherein the actuator comprises a motor.

10. The air outlet of claim 1 wherein the first upper slot comprises a first pair of upper slots and the second upper slot comprises a second pair of upper slots and wherein the first lower slot comprises a first pair of lower slots and the second lower slot comprises a second pair of lower slots.

11. The air outlet of claim 10 wherein the flexible upper wall comprises first extensions slidable engaging the first pair of upper slots and the second pair of upper slots and the flexible lower wall comprises second extensions slidable engaging the first pair of lower slots and the second pair of lower slots.

12. The air outlet of claim 11 wherein the first pair of upper slots, the second pair of upper slots, the first pair of lower slots and the second pair of lower slots are horizontally disposed.

13. The air outlet of claim 11 wherein the first side wall and the second side wall are coupled to an upper wall and a lower wall to form a housing.

14. The air outlet of claim 13 further comprising an upper seal disposed adjacent to the upper wall.

15. The air outlet of claim 14 further comprising a lower seal disposed adjacent to the lower wall.

16. The air outlet of claim 13 further comprising a side seal disposed adjacent to the first side wall.

17. The air outlet of claim 1 wherein the control arm is coupled to an actuator.

18. The air outlet of claim 17 wherein the actuator comprises a motor.

19. The air outlet of claim 1 wherein the flexible upper wall comprises first center extensions and the flexible lower wall comprises a second center extension.

20. The air outlet of claim 19 wherein one of the first center extensions is coupled to the control arm, a second of the first center extensions and the second center extension coupled to the coupling member.
